(19) United States
(12) Patent Application Publication
(10) Pub. No.: US 2009/0228230 A1
(43) Pub. Date: Sep. 10, 2009

(54) System and method for real-time detection of gas turbine or aircraft engine blade problems

(75) Inventors: Vinay Bhaskar Jammu, Bangalore (IN); Sudhanshu Rai, Bangalore (IN); Srihari Balasubramanian, Clifton Park, NY (US); Mandar Kalidas Chati, Mason, OH (US); Omprakash Velagandula, Niskayuna, NY (US); Nirm Velumylum Nirmalan, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/075,059

(22) Filed: Mar. 6, 2008

(51) Int. Cl. G06F 19/00; G01N 25/00

(52) U.S. Cl. 702/113; 374/57

(57) ABSTRACT

A method and system are implemented to detect gas turbine blade problems in real time and provide more accurate prediction capabilities than known techniques due to inclusion of physics-based correction and temperature modeling methods for the hot gas path parts lifing. The system and method use pyrometer data and operational data to generate physics-based corrections of pyrometer data and physics-based bucket temperature estimations and failure signatures.

### BACKGROUND

The invention relates generally to gas turbines and aircraft engines, and more specifically a method and system for detecting gas turbine blade and aircraft engine problems in real time.

Gas turbine engines operate at relatively high temperatures. The capacity of such an engine is limited to a large extent by the ability of the material from which the turbine blades (sometimes referred to herein as buckets) are made to withstand thermal stresses which develop at such relatively high operating temperatures. The problem may be particularly severe in an industrial gas turbine engine because of the relatively large size of the turbine blades.

Hollow, convectively-cooled turbine blades are frequently utilized to enable higher operating temperatures and increased engine efficiency without risking blade failure. Such blades generally have interior passageways which provide flow passages to ensure efficient cooling, wherein all the portions of the blades may be maintained at relatively uniform temperatures.

Thermal barrier coatings on the gas turbine buckets protects the bucket base material from very high temperatures that the buckets experience due to high temperature expanding gas in the hot gas path of the turbine. The buckets experience various failures such as thermal barrier coating spallation cracks on leading and trailing edges of the turbine blade and platform cracking due to the harsh environment in the hot gas path of the turbine. Other undesired bucket failures may include without limitation, cooling passage blockages. These failure modes have a potential to cause unplanned maintenance if they result in catastrophic failure such as blade breakage. They also can cause significant damage due to loss of failed parts that are no longer repairable. The secondary damage and the loss of revenue due to loss of power from the plant can be significant for the power plant operators.

In view of the foregoing, it would be both advantageous and beneficial to provide a system and method for implementing reliable real-time detection of gas turbine blade and aircraft engine problems.

### BRIEF DESCRIPTION

Briefly, in accordance with one embodiment, a gas turbine or aircraft engine bucket failure mode detection system is configured to identify changes between measured relative or absolute bucket temperatures and baseline temperatures.

According to another embodiment, a system for detecting gas turbine or aircraft engine bucket failure modes comprises:

a first pyrometer and at least one on-site monitor configured together to generate gas turbine or aircraft engine operational parameters;

a first model based filter configured to reduce variations in pyrometer signals based on variations in the operational parameters and to generate a first corrected pyrometer signal therefrom;

a first physics-based signal processor configured to generate a normalized gas turbine or aircraft engine bucket temperature signature in response to the corrected pyrometer signal;

a bucket failure mode signature database; and

a first comparator configured to compare the normalized gas turbine or aircraft engine bucket temperature signature with bucket failure mode signature data within the database to identify a failure mode associated with a failed bucket.

According to yet another embodiment, a method for detecting gas turbine or aircraft engine bucket failure modes comprises:

monitoring gas turbine or aircraft engine operational parameters in real-time via a pyrometer and at least one on-site monitor;

filtering pyrometer signals based on variations in the operational parameters and generating a corrected pyrometer signal therefrom;

generating a normalized gas turbine or aircraft engine bucket temperature signature in response to the corrected pyrometer signal;

generating a bucket failure mode signature database offline; and

comparing the normalized gas turbine or aircraft engine bucket temperature signature with bucket failure mode signature data within the database to identify a failure mode associated with a failed bucket.

### DRAWINGS

These and other features, aspects, and advantages of the present invention will become better understood when the following detailed description is read with reference to the accompanying drawings in which like characters represent like parts throughout the drawings, wherein:

FIG. 1 is a chart illustrating method and system for detecting gas turbine or aircraft engine blade problems in real time according to one embodiment;

FIG. 2 is a pictorial diagram illustrating a system and method for detecting gas turbine or aircraft engine blade problems according to another aspect of the invention;

FIG. 3 is a graph illustrating the large variation in raw operational data generally associated with a gas turbine or aircraft engine operational pyrometer signal in real time;

FIG. 4 is a graph illustrating the raw data depicted in FIG. 3 that has been corrected by the monitoring system illustrated in FIG. 1; and

FIG. 5 is a graph illustrating gas turbine or aircraft engine pyrometer measurement values associated with a plurality of buckets generated in real time by the monitoring system illustrated in FIG. 1.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

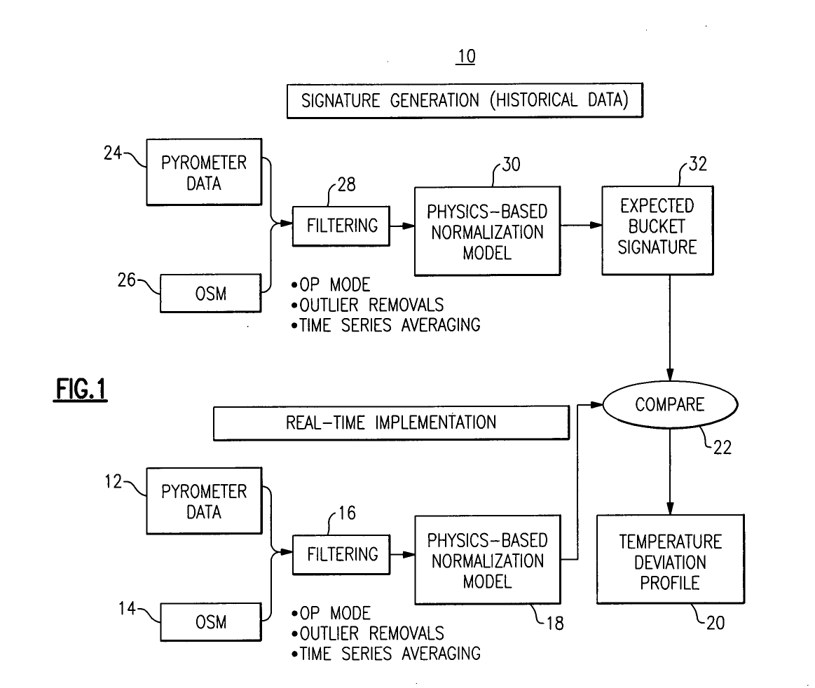

FIG. 1 is a flow chart illustrating method and system 10 for detecting gas turbine or aircraft engine blade problems in real time according to one embodiment. System 10 provides a means for real-time detection of gas turbine or aircraft engine blade problems including without limitation, thermal barrier coating spallation, cracks, and cooling passage blockages in gas turbine or aircraft engine buckets while the turbine or aircraft engine is in operation using gas turbine or aircraft engine operational data and optical pyrometer data.

According to one aspect, system 10 employs at least one optical pyrometer 12 to generate the optical pyrometer data. A monitoring system based on optical pyrometer data is difficult to develop however, due to the need for knowledge of absolute temperature value of the bucket. The signal acquired by the optical pyrometer 12 may be difficult to base with respect to an absolute temperature due to, for example, emissivity variations and/or blockages in the optical paths.

The foregoing difficulties are remedied via the system 10 for detecting gas turbine or aircraft engine blade problems in real time. System 10 uses relative temperature changes to implement the desired diagnosis. A baseline from when the buckets are new is generated and compared in real time with newer pyrometer readings to identify deviations that could be indicative of bucket failures.

System 10 resolves two issues that arise with the relative temperature approach. The two issues that are resolved include 1) the difficulty in identifying an abnormal deviation in the presence of significant variations in baseline reading of normal buckets due to operational conditions such as ambient temperatures, loads, and so on, and 2) the difficulty in developing a library of signatures for failed buckets that can be employed to co-relate known signature values to specific failure modes.

The foregoing two issues are resolved by system 10 that provides a process for reducing variations in the pyrometer readings in the presence of variations in operating conditions using a physics-based signal processor 18 to generate signatures for failed buckets. The system 10 is now described herein below in more detail with reference to FIG. 1.

Looking again at FIG. 1, system 10 for detecting gas turbine or aircraft engine blade problems in real time includes at least one pyrometer 12 that operates in real time to monitor and generate pyrometer temperatures signals. At least one on-site monitor 14 is also employed by system 10. This at least one on-site monitor 14 in one aspect, operates to monitor and generate additional temperature data, pressure data, load, combustion dynamics data, and other desired operational parameters.

The foregoing pyrometer temperature data and on-site monitor data are together processed via a filter 16 where model based corrections are made to the pyrometer data and reduce the variations in the pyrometer signal due to operational condition variations. The present inventors found this approach to reduce variations in bucket signatures by about 70% to about 80% when using the standard deviation as a measure of variation. The filter 16 then generates a corrected pyrometer temperature signature that is used as a boundary condition for a signal processor that operates as a physics-based normalization model 18.

The physics-based normalization model 18, using the corrected pyrometer temperature signature as a boundary condition, then performs an extrapolation to arrive at the requisite full bucket temperature(s).

A database of bucket failure mode signatures is generated independently off line using a corresponding filter 28 and a corresponding physics-based normalization model 30. Filter 28 generates model based corrections to pyrometer data 24 and reduces the variations in the associated pyrometer signal due to induced operational condition variations. The filter 28 then generates a corrected pyrometer temperature signature that is used as a boundary condition for a signal processor that operates as a physics-based normalization model 30 to generate full bucket temperature profiles. Once the full bucket temperatures are determined, the pyrometer signature as seen by the optical pyrometer is extracted from the physics based model 30 and stored in a library of normal and abnormal signatures 32 representing failed buckets.

The library of normal and abnormal signatures 32 representing failed buckets are then compared via a comparator 22 with the bucket signature(s) determined in real-time via physics-based normalization model 18. The real-time signature that matches closest with respect to one of the failed bucket signatures 32 stored in the library (database) is then identified to have that failure mode.

The library (database) of normal and abnormal signatures representing failed buckets can be further refined using data obtained from off line validation techniques using field data taken during individual blade inspection(s). This field data can be used to validate predictions from the system 10 and improve its performance.

In summary explanation, a method and system 10 for detecting gas turbine or aircraft engine blade problems in real time provides more accurate prediction capabilities than known techniques due to inclusion of physics-based correction and temperature modeling methods for the hot gas path parts lifing. The system 10 uses pyrometer data and operational data to generate physics-based corrections of pyrometer data and physics-based bucket temperature estimations and failure signatures.

Those skilled in the aircraft engine art will readily appreciate the principles described herein are easily applied to both gas turbines and aircraft engines, among other applications.

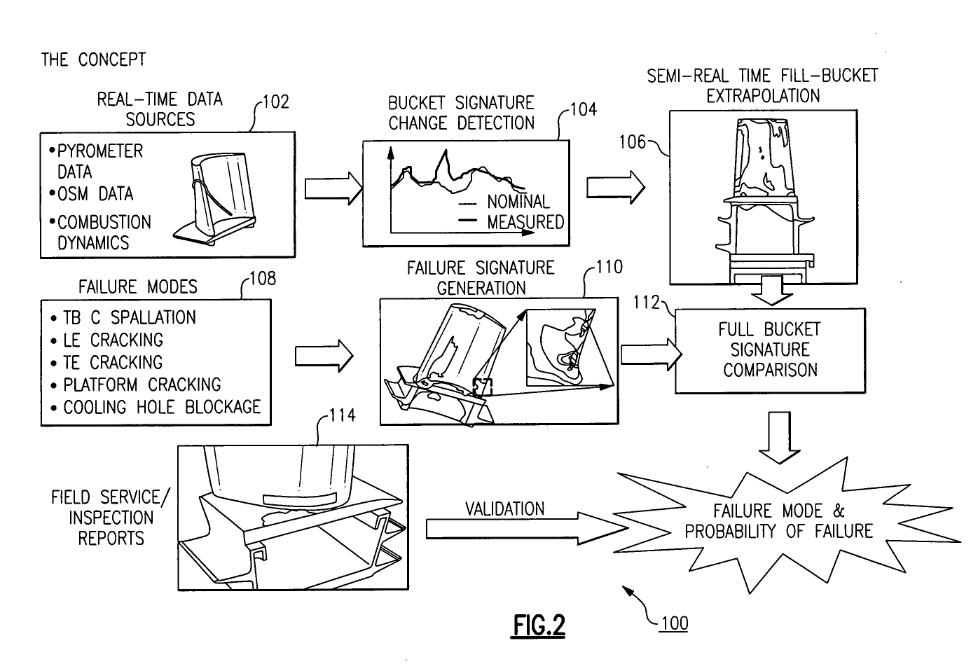

Moving now to FIG. 2, a simplified pictorial diagram illustrates a method and system 100 for detecting gas turbine blade problems or aircraft engine problems according to another aspect of the invention. Real-time data 102 including without limitation, pyrometer data, on-site monitor data, and combustion dynamics data associated with induced failure modes are monitored as represented in block 104 and processed as represented in block 106 to generate a database of bucket or other types of failure mode signatures independently off line in semi-real time as represented in block 106.

System 100 then operates in real time to monitor bucket failure or other types of failure modes including without limitation, thermal barrier coating spallation, LE cracking, TE cracking, platform cracking, and cooling passage blockage as represented in block 108. Failure signatures corresponding to the various failure modes are generated as represented in block 110.

The failure mode signatures determined in real-time are then compared with the database of bucket failure mode signatures or other types of failure mode signatures determined independently off line in semi-real time to determine the real-time signature that matches closest with respect to one of the failed bucket signatures or other types of failure signatures stored in the database to correctly identify that failure mode as represented in block 112.

Data obtained from off line validation techniques such as field service data and/or inspection reports taken during, for example, individual blade inspection(s) can be used to validate predictions from the system 100 and improve its performance as represented in block 114.

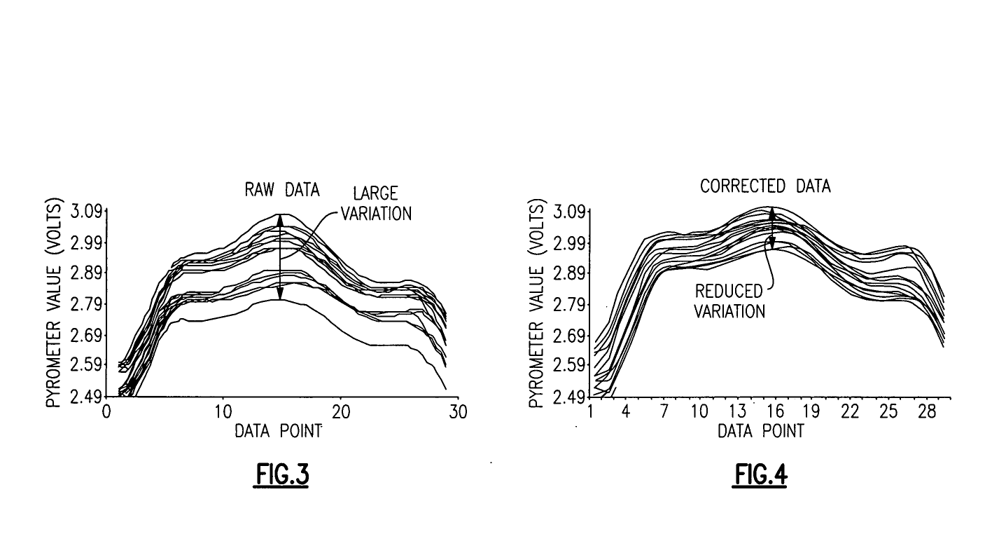

FIG. 3 is a graph illustrating the large variation in raw operational data associated with a gas turbine operational parameter pyrometer signal generated in real time. The graph shows that a particular failure mode is difficult to identify using the raw data since the variation is large.

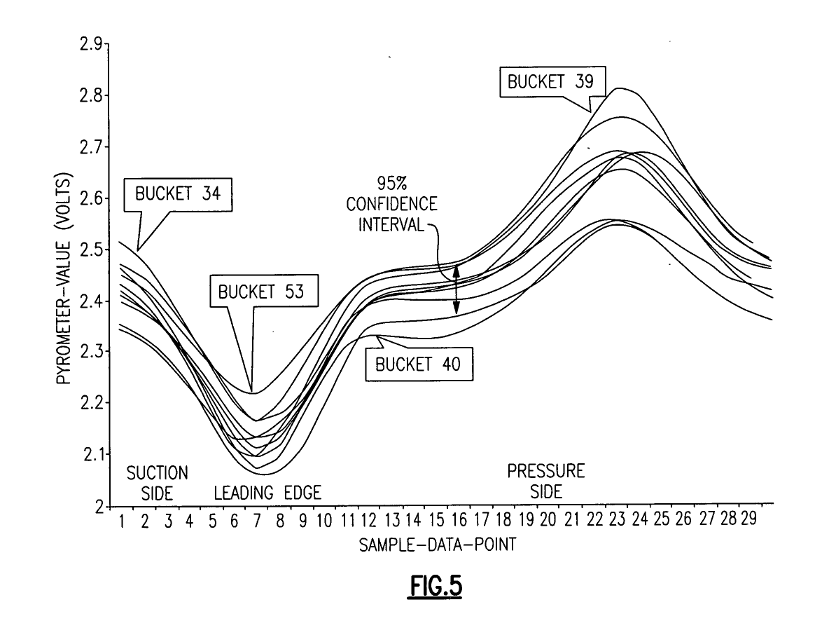

FIG. 4 is a graph illustrating the raw data depicted in FIG. 3 that has been corrected by the monitoring system 10 described above with reference to FIG. 1. The graph shows that particular failure modes are much easier to identify using the corrected raw data that now has a substantially reduced variation in the pyrometer data.

FIG. 5 is a graph illustrating gas turbine pyrometer measurement values associated with a plurality of buckets generated in real time by the monitoring system 10. The range of values associated with the buckets that is generated by monitoring system 10 is very small, while the confidence interval associated with the variation in the pyrometer data is high, at about 95%, demonstrating the capabilities of the system 10 to provide a gas turbine or aircraft engine bucket failure mode detection system configured to identify changes between measured relative or absolute bucket temperatures and baseline temperatures.

Those skilled in the aircraft engine art will appreciate that the principles described herein are equally applicable to both gas turbines and aircraft engines and that pyrometer data can be used just as well to monitor aircraft engine operational data in accordance with the principles described herein above.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A gas turbine or aircraft engine bucket failure mode detection system configured to identify changes between measured relative or absolute bucket temperatures and baseline temperatures.

2. The gas turbine or aircraft engine bucket failure mode detection system according to claim 1, wherein the baseline temperatures are based on pyrometer monitoring data and at least one on-site monitor configured to monitor desired operational parameters.

3. The gas turbine or aircraft engine bucket failure mode detection system according to claim 2, wherein the operational parameters are selected from gas turbine or aircraft engine temperatures, pressures, load, and combustion dynamics.

4. The gas turbine or aircraft engine bucket failure mode detection system according to claim 2, wherein the pyrometer and the at least one on-site monitor are configured together to monitor gas turbine or aircraft engine operational parameters in real-time.

5. The gas turbine or aircraft engine bucket failure mode detection system according to claim 1, wherein the bucket relative temperature is generated via a model based filter configured to reduce variations in pyrometer signals based on variations in desired operational parameters and to generate a corrected pyrometer signal therefrom.

6. The gas turbine or aircraft engine bucket failure mode detection system according to claim 5, further configured generate a normalized gas turbine or aircraft engine bucket temperature signature in response to the corrected pyrometer signal.

7. The gas turbine or aircraft engine bucket failure mode detection system according to claim 1, further configured to identify a failure mode associated with a failed bucket.

8. The gas turbine or aircraft engine bucket failure mode detection system according to claim 7, wherein the failure mode is identified via a bucket failure mode signature database and a comparator configured to compare a normalized gas turbine or aircraft engine bucket temperature signature with bucket failure mode signature data within the database to identify the failure mode associated with a failed bucket.

9. The gas turbine or aircraft engine bucket failure mode detection system according to claim 1, wherein the bucket relative temperature differences correlate with bucket failure modes selected from bucket thermal barrier coating spallation, bucket cracks, bucket platform cracks, and bucket cooling passage blockages.

10. A gas turbine or aircraft engine bucket failure mode detection system comprising:
a first pyrometer and at least one on-site monitor configured together to generate gas turbine or aircraft engine operational parameters;
a first model based filter configured to reduce variations in pyrometer signals based on variations in the operational parameters and to generate a first corrected pyrometer signal therefrom;
a first physics-based signal processor configured to generate a normalized gas turbine or aircraft engine bucket temperature signature in response to the corrected pyrometer signal;
a bucket failure mode signature database; and
a first comparator configured to compare the normalized gas turbine or aircraft engine bucket temperature signature with bucket failure mode signature data within the database to identify a failure mode associated with a failed bucket.

11. The gas turbine or aircraft engine bucket failure mode detection system according to claim 10, wherein the operational parameters are selected from gas turbine temperatures, pressures, load and combustion dynamics.

12. The gas turbine or aircraft engine bucket failure mode detection system according to claim 10, wherein the failure mode signature data are associated with bucket failure modes selected from bucket thermal barrier coating spallation, bucket cracks, bucket platform cracks, and bucket cooling passage blockages.

13. The gas turbine or aircraft engine bucket failure mode detection system according to claim 10, further comprising a second pyrometer and at least one additional on-site monitor configured together to generate gas turbine or aircraft engine bucket operational parameters in response to various induced bucket failure modes.

14. The gas turbine or aircraft engine bucket failure mode detection system according to claim 13, further comprising a second model based filter configured to reduce variations in pyrometer signals based on variations in the operational parameters generated in response to various induced bucket failure modes and to generate a corrected second pyrometer signal therefrom.

15. The gas turbine or aircraft engine bucket failure mode detection system according to claim 14, further comprising a second physics-based signal processor configured to generate a normalized gas turbine or aircraft engine bucket temperature signature in response to the corrected second pyrometer signal.

16. A method for detecting gas turbine or aircraft engine bucket failure modes, the method comprising:
monitoring gas turbine or aircraft engine bucket operational parameters in real-time via a pyrometer and at least one on-site monitor;
filtering pyrometer signals based on variations in the operational parameters and generating a corrected pyrometer signal therefrom;
generating a normalized gas turbine or aircraft engine bucket temperature signature in response to the corrected pyrometer signal;
generating a bucket failure mode signature database offline; and
comparing the normalized gas turbine or aircraft engine bucket temperature signature with bucket failure mode signature data within the database to identify a failure mode associated with a failed bucket.

17. The method for detecting gas turbine or aircraft engine bucket failure modes according to claim 16, wherein monitoring gas turbine or aircraft engine operational parameters in real-time via a pyrometer and at least one on-site monitor comprises monitoring gas turbine or aircraft engine operational parameters selected from temperatures, pressures, load, combustion dynamics.

18. The method for detecting gas turbine or aircraft engine bucket failure modes according to claim 16, wherein filtering pyrometer signals based on variations in the operational parameters and generating a corrected pyrometer signal therefrom comprises processing the pyrometer signals via a modeling filter to reduce variations in the pyrometer signal due to operational condition variations.

19. The method for detecting gas turbine or aircraft engine bucket failure modes according to claim 16, wherein generating a normalized gas turbine or aircraft engine bucket temperature signature in response to the corrected pyrometer signal comprises processing the bucket failure mode data via a physics-based normalization model element to generate the normalized gas turbine or aircraft engine bucket temperature signature.

20. The method for detecting gas turbine or aircraft engine bucket failure modes according to claim 16, wherein generating a bucket failure mode signature database offline comprises:
inducing various bucket failure modes and generating bucket failure mode data therefrom; and
processing the bucket failure mode data via a physics-based normalization model element to generate a library of normal and abnormal signatures representing failed buckets.

21. The method for detecting gas turbine or aircraft engine bucket failure modes according to claim 16, wherein comparing the normalized gas turbine or aircraft engine bucket temperature signature with bucket failure mode signature data within the database to identify a failure mode associated with a failed bucket comprises comparing the normalized gas turbine or aircraft engine bucket temperature signature with bucket failure mode signature data within the database and generating a temperature deviation profile therefrom.
